(19) United States
(12) Patent Application Publication
(10) Pub. No.: US 2026/0301111 A1
(43) Pub. Date: Oct. 1, 2026

(54) SOFTWARE-ASSISTED HARDWARE CACHE FOR TEXTURE DECOMPRESSION

(71) Applicant: NVIDIA Corporation, Santa Clara, CA (US)

(72) Inventors: Tomas Akenine-Moller, Lund (SE); Karthik Vaidyanathan, Oakland, CA (US)

(21) Appl. No.: 19/093,002

(22) Filed: Mar. 27, 2025

(51) Int. Cl. G06T 1/60; G06T 9/00; G06T 15/00; G06T 15/04

(52) U.S. Cl. CPC G06T 1/60; G06T 9/002; G06T 15/005; G06T 15/04; G06T 2210/08

(57) ABSTRACT

In computer graphics, texture refers to a type of surface, including the material characteristics, that can be applied to an object in an image. In some implementations, a texture may be represented as an image that can be placed on a three-dimensional (3D) model of an object to give surface details to the 3D object. To reduce a size of textures (e.g. for storage and transmission), textures may be compressed. However, current decompression methods that execute in software shader code are costly, especially where high compression ratios are involved. The present disclosure provides for a software-assisted hardware cache for texture decompression, which can be used to access already decompressed textures thereby reducing a number of decompressions required to be performed.

### TECHNICAL FIELD

The present disclosure relates to texture decompression for computer graphics.

### BACKGROUND

In computer graphics, texture refers to a type of surface, including the material characteristics, that can be applied to an object in an image. A texture may be defined using numerous parameters, such as color(s), roughness, glossiness, etc. In some implementations, a texture may be represented as an image that can be placed on a three-dimensional (3D) model of an object to give surface details to the 3D object. Textures can accordingly be used to provide photorealism in computer graphics, but they also have certain storage, bandwidth, and memory demands. Thus, limited disk storage, download bandwidth, and memory size constraints must be addressed to continuously improve photorealism in computer graphics via more detailed and available textures.

As a solution to reduce these resource demands, textures can be compressed (i.e. reduced in size using some preconfigured compression algorithm) prior to storage and/or network transmission. Existing texture compression methods include block-based texture compression and neural texture compression. However, while texture compression can reduce storage and/or transmission requirements, there is some cost for decompression. The cost can be especially significant for textures compressed at high compression ratios.

Currently, programmable texture decompression, especially for neural texture compression methods, is typically done in software in shader code executing on the streaming multiprocessor of a graphics processing unit (GPU). It is so expensive to decompress with this implementation that one cannot usually afford to do a trilinear nor a bilinear lookup, which would require 8 or 4, respectively, decompressions of compressed texels. Instead, researchers have invented stochastic texture filtering (STF) as a possible solution. With STF, only a single compressed texel is decompressed, but it is chosen stochastically to average to the correct result. Unfortunately, for magnification, STF does not do any type of interpolation, and as a result the quality can be poor, especially if there are non-linear shading terms, such as a normal map, applied.

There is thus a need for addressing these issues and/or other issues associated with the prior art. For example, there is a need to provide a software-assisted hardware cache for texture decompression, which can be used to access already decompressed textures thereby reducing a number of decompressions required to be performed.

### SUMMARY

A method, computer readable medium, and system are disclosed to use a cache for image data decompression. Responsive to identifying a compressed representation of image data that is to be decompressed, it is determined whether the image data is stored in a cache. When the image data is stored in the cache, the image data is accessed from the cache.

### BRIEF DESCRIPTION OF THE DRAWINGS

FIG. 1 illustrates a flowchart of an image data decompression method, in accordance with an embodiment.

FIG. 2 illustrates a software-assisted hardware cache system, in accordance with an embodiment.

FIG. 3 illustrates the hardware unit of FIG. 2, in accordance with an embodiment.

FIG. 4 illustrates a flowchart of a method for consulting a cache during image data decompression, in accordance with an embodiment.

FIG. 5 illustrates a flowchart of a method for using decompressed image data to render an image, in accordance with an embodiment.

FIG. 6 illustrates an exemplary computing system, in accordance with an embodiment.

### DETAILED DESCRIPTION

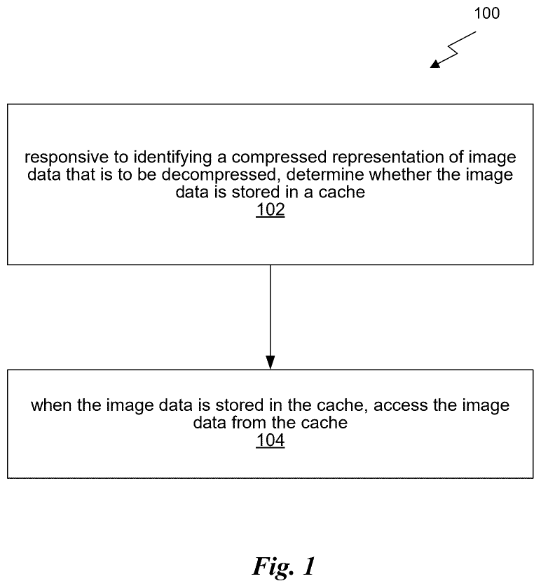

FIG. 1 illustrates a flowchart of an image data decompression method 100, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

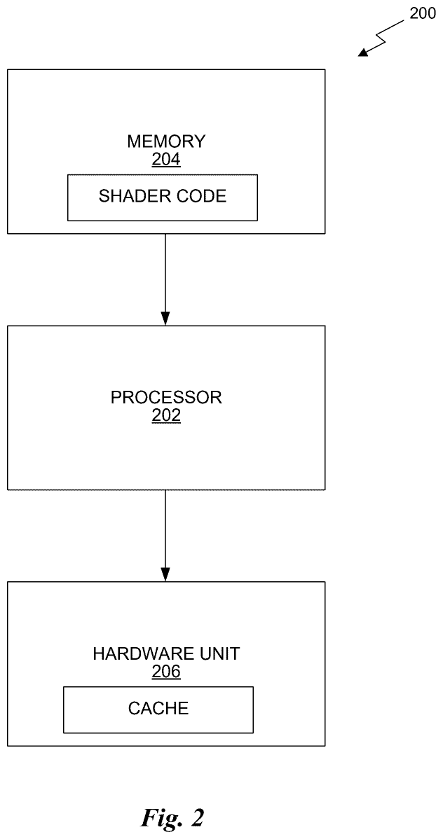

In a particular embodiment, the method 100 may be performed in software. The software may be a shader comprised of shader code executing on a processor, such as a streaming multiprocessor of a GPU. The software may interface a hardware cache that stores decompressed image data. FIG. 2 below provides further explanation of the software that may perform the method 100 described herein.

As mentioned, the method 100 is an image data decompression method. In particular, the method 100 is performed when a compressed representation of image data is to be decompressed. This may occur when the image data is requested by a process, task, application, or other source, for example for use in rendering an image, for example. In an embodiment, the method 100 may be performed for each thread of a program tasked with decompressing respective image data.

With respect to the present description, the image data refers to data that defines one or more aspects of an image. In an embodiment, the image data may be a texel. In another embodiment, the image data may be a plurality of texels. In an embodiment, the image data may include at least a portion of a texture. In another embodiment, the image data may include at least a portion of a set of textures. In an embodiment, the set of textures may represent a material, including for example where each texture of set of textures represents a different property of the material.

Further still, the compressed representation of the image data refers to any representation of the image data that is compressed with respect to the image data itself. The compressed representation may be smaller in size (memory-wise) than the original (uncompressed) image data. The compressed representation of the image data may have been generated using at least one compression method. The compression method may be a block compression method, a neural texture compression method, or any compression method for which decompression is not supported in hardware. In an embodiment, the compressed representation of the image data may have been learned using a neural network.

Returning to the method 100, in operation 102, responsive to identifying a compressed representation of image data that is to be decompressed, it is determined whether the image data is stored in a cache. In an embodiment, the image data may be stored in the cache when the compressed representation of the image data has been previously decompressed (i.e. and the resulting (decompressed) image data stored in the cache).

In an embodiment, determining whether the image data is stored in the cache may include sending a request to a hardware unit with an address or other unique identifier of the image data or of the compressed representation of the image data, and receiving a response from the hardware unit indicating whether the image data is stored in the cache. In an embodiment, the hardware unit may include the cache.

In operation 104, when the image data is stored in the cache, the image data is accessed from the cache. Access the image data from the cache refers to reading, or otherwise retrieving, the image data from the cache. Once accessed from the cache, the image data may be returned to the source that prompted the decompression of the compressed representation of the image data as identified in operation 102.

By accessing the image data from the cache, decompression of the compressed representation of the image data is avoided. In other words, the compressed representation of the image data may be decompressed once to access the image data which is then stored in the cache for future access(es). This eliminates the need to decompress the compressed representation of the image data every time the image data is to be accessed, at least while the image data is stored in the cache.

Further embodiments will now be provided in the description of the subsequent figures. It should be noted that the embodiments disclosed herein with reference to the method 100 of FIG. 1 may apply to and/or be used in combination with any of the embodiments of the remaining figures below.

FIG. 2 illustrates a software-assisted hardware cache system 200, in accordance with an embodiment. The system 200 may be implemented to carry out the method 100 of FIG. 1, in an embodiment. The definitions and description provided above may equally apply to embodiments described herein.

As shown, the system includes a processor 202, a memory 204 storing shader code, and a hardware unit 206 that includes a cache. The processor 202 may be a GPU or a streamlining multiprocessor of the GPU, or any other hardware process configured to execute shader code, in embodiments. The processor 202 accesses the shader code from the memory 202 and executes the same for image data decompression.

In particular, during execution of the shader code by the processor 202, it is determined that a compressed representation of image data is to be decompressed. The compressed representation of the image data may be stored in the memory 204 or another memory (not shown). The compressed representation of the image data may be required to be decompressed for use in rendering an image.

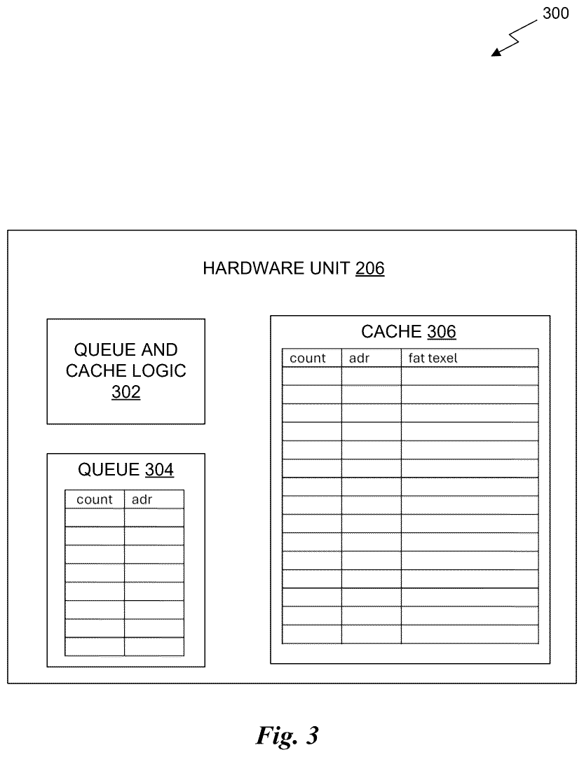

Responsive to determining that the compressed representation of the image data is to be decompressed, the processor 202 executing the shader code determines whether the image data is stored in the cache of the hardware unit 206. In the present embodiment, the processor 202 sends a request to the hardware unit 206 with an address or other unique identifier of the image data, and the hardware unit 206 returns a response indicating whether the image data is stored in the cache. FIG. 3 below describes an implementation of the hardware unit 206 for processing the request from the processor 202.

When the image data is stored in the cache, the image data is accessed from the cache. In an embodiment, the hardware unit 206 may return the image data from the cache to the processor 202. In another embodiment, the hardware unit 206 may return a location (e.g. address) of the image data in the cache to the processor 202 and the processor 202 may in turn use the location to access the image data.

When the image data is not stored in the cache, the image data may not be accessed from the cache and another method may be performed to obtain the image data. In an embodiment, when the image data is not stored in the cache, as indicated in the response from the hardware unit 206 to the processor 202, then the processor 202 may decompress the compressed representation of the image data in order to obtain the image data.

In another embodiment, the hardware unit 206 may be configured to determine, responsive to the request, whether the compressed representation of the image data is currently in the process of being decompressed by another thread. In an embodiment, when the compressed representation of the image data is not stored in the cache and is not currently in the process of being decompressed by another thread, as indicated in the response from the hardware unit 206 to the processor 202, then the processor 202 may decompress the compressed representation of the image data in order to obtain the image data.

In another embodiment, when the compressed representation of the image data is not stored in the cache but is currently in the process of being decompressed by another thread, as indicated in the response from the hardware unit 206 to the processor 202, then the processor 202 may wait for the image data to be stored to the cache once decompressed by the other thread, and then after the image data is stored to the cache by the other thread the processor 202 may access the image data from the cache. In an embodiment, while waiting for the image data to be stored to the cache, the processor 202 may switch to processing another compressed representation of other image data that is to be decompressed (e.g. per the method 100 of FIG. 1).

To this end, the processor 202 may determine whether the image data is stored in the cache by sending a request to the hardware unit 306 with an address of the image data, and receiving a response from the hardware unit 306 that includes one of:
(1) the image data is stored in the cache,
(2) the image data is not stored in the cache and the compressed representation of the image data is not currently in the process of being decompressed by another thread and there is available space in the cache to decompress the compressed representation of the image data to the cache,
(3) the image data is not stored in the cache and the compressed representation of the image data is not currently in the process of being decompressed by another thread and there is no available space in the cache to decompress the compressed representation of the image data to the cache, or
(4) the image data is not stored in the cache and the compressed representation of the image data is currently in the process of being decompressed by another thread.

FIG. 3 illustrates the hardware unit 206 of FIG. 2, in accordance with an embodiment. The present embodiment provides one possible implementation of the hardware unit 206 of FIG. 2, but of course other implementations that support the operations of the hardware unit 206 described above may also be considered.

The embodiments described herein are disclosed in the context of image data that is comprised of a fat texel. In neural texture compression where an entire material texture consisting of many channels is compressed, the collection of all channels for a certain integer coordinate is referred to as a fat texel in the material texture. The material texture identifier together with the integer coordinate can be used to compute a unique identifier, or address, for the fat texel. Thus, while embodiments described herein may refer to the address of the image data or the address of the compressed representation of the image data (e.g. fat texel), it should be noted that other embodiments are also contemplated in which the address refers to any unique identifier of any compressed representation of image data.

As shown, the hardware unit 206 includes queue and cache logic 302 that is configured to interface a queue 304 and cache 306 as described herein. In particular, any request from the processor 202 of FIG. 2 for image data may be processed by the queue and cache logic 302.

When the processor 202 sends a request to the hardware unit 206 with the address of the image data, the queue and cache logic 302 may determine from the cache 306 whether the image data is stored therein. When the image data is stored in the cache 306, then the image data may be accessed from the cache 306 (e.g. by the processor 202).

When the image data is not stored in the cache 306, the queue and cache logic 302 may determine from the queue 304 whether the compressed representation of the image data is currently in the process of being decompressed. The queue 304 is configured with a counter that tracks when the compressed representation of the image data is currently in the process of being decompressed (e.g. by a thread). The counter may also track as a number of additional threads waiting to access the image data once the decompression is complete. As shown, the queue 304 includes a plurality of entries, each of which store the counter for an image data and an address of the image data. Thus, the queue 304 may be configured to track decompressions for up to a predefined number of different image data.

When the queue and cache logic 302 determines from the queue 304 that the compressed representation of the image data is not currently in the process of being decompressed, then the hardware unit 206 notifies the processor 202 of the same which may prompt the processor 202 to decompress the compressed representation of the image data.

When the queue and cache logic 302 determines from the queue 304 that the compressed representation of the image data is currently in the process of being decompressed, then the hardware unit 206 notifies the processor 202 of the same which may prompt the processor 202 to wait until the decompression completes and until the image data is stored in the cache 306 for access.

When decompression of a compressed representation of an image data is initiated by the processor 202 and when there is space in a queue 304 of the hardware unit 206 for a counter for the image data, then the counter for the image data may be updated (e.g. incremented) in the queue 304 to indicate that the compressed representation of the image data is in the process of being decompressed.

Further, after the decompressing is complete, the image data may be stored in the cache 306 and the counter for the image data in the queue 304 may be updated (e.g. decremented) to indicate that the compressed representation of the image data is not in the process of being decompressed. This counter may be updated to indicate that a current thread is waiting for the image data to be stored to the cache 306 once decompressed by another other thread.

After the counter for the image data is updated in the queue 304, then a current value of the counter may be stored with the image data in the cache 306. As shown, the cache 306 may include a counter that tracks a number of threads accessing the image data from the cache 306.

In an embodiment, a hardware mechanism may be used to signal any threads waiting on the decompression to complete. In one embodiment, every sample request may be associated with a scoreboard (can be allocated by the compiler from a fixed pool similar to how loads are handled). The processor 202 may set this scoreboard on the sample request and clear it when the fat texel is decompressed and stored in the cache. The compiler may mark an instruction that is directly dependent on this scoreboard, and the processor 202 may stall if this instruction is reached until the scoreboard is cleared. The compiler may have the freedom to schedule other instructions that are not directly or indirectly dependent on the scoreboard in between the sample instruction and this instruction waiting on the scoreboard.

In an embodiment, the image data may be removed from the cache 306 when a value of its counter in the cache 306 is zero. In another embodiment, the image data may be removed from the cache 306 when the value of its counter in the cache 306 is zero, when the cache 306 is full, and when new image data is to be decompressed and stored in the cache 306.

Table 1 illustrates possible commands that the processor 202 can send to the hardware unit 206.

TABLE 1

| Command | Description |
|---|---|
| ftc_request(C) | request information about what is in the cache |
| | or queue with respect to the address C. An |
| | integer is returned with the status and after |
| | that the appropriate action can be taken. |
| P = ftc_read(C) | read the cache at address C |
| ftc_wait_for_fat_texel(C) | some other thread is decompressing the fat |
| | texel at C, and this issues a wait command |
| | that returns when the cache has the data |
| | available |
| ftc_wait_for_free_cacheline(C) | when a thread has decompressed a fat texel, |
| | there needs to be an available cacheline in the |
| | cache, and this command waits until there is |
| | such a cacheline. Also, the cache reserves this |
| | cacheline for C |
| ftc_store(C, P) | stores a decompressed fat texel P for address |
| | C in the cache |

Table 2 illustrates possible request results identified by the hardware unit 206 for the ftc_request(C) command.

| Request | | Counter on | Shader code (processor 202) | Counter on |
|---|---|---|---|---|
| result | Meaning | request | following ftc_request(C) | done |
| 0 | Fat texel is in | +1 in cache | P = ftc_read(C); | −1 |
| | FTC already | | | |
| 1 | Another thread | +1 in queue | ftc_wait_for_fat_texel(C); P = | −1 |
| | is | | ftc_read(C); | |
| | decompressing | | | |
| | for C | | | |
| 2 | Not in cache, | +1 in queue | P = decompress_NTC(C); | −1 |
| | no one is | | ftc_wait_for_free_cacheline(C); | |
| | decompressing, | | ftc_store(C, P); | |
| | so this thread | | | |
| | decompresses. | | | |
| 3 | Fat texel is not | Nothing | P = decompress_NTC(C); | Nothing |
| | in cache, no one | | | |
| | is | | | |
| | decompressing | | | |
| | it, and no space | | | |
| | in queue | | | |

Table 3 illustrates exemplary pseudocode for the shader code executing on the processor 202.

```
TABLE 3
C = (NTC_texture_id, x,y) // Address of the fat texel this thread wants to access.
FatTexel P;
int result = ftc_request(C);
if(result == 0) // Fat texel is already in the cache.
{
P = ftc_read(C); // Performs decrement of count at C.
}
else if(result == 1) // Another thread is currently computing (decompression) the texel at
  // C.
{
ftc_wait_for_fat_texel(C); // Possibly with thread switch.
P = ftc_read(C); // Performs decrement of count at C.
}
else if(result == 2) // Not in cache, and not currently being decompressed, so this thread
  //will decompress
{
P = decompress_NTC(C); // Done on processor.
ftc_wait_for_free_cacheline(C); // There must be a spot in the cache to proceed.
ftc_store(C, P);
}
else if(result == 3) // Not in cache, not currently being decompressed, and no space in
  //cache
{
P = decompress_NTC(C); // Done on the processor, and then not cached because there
    //are no resources for this.
}
S = compute_shading(P); // Compute shading using the fat texel data P.
```

### Conditional Use of the Cache

In an embodiment, the method 100 may be performed by the shader when an area of a pixel footprint in texel space is within a defined threshold. For example, the method 100 and/or system 200 described may only be used when there is some level of magnification of the texture going on, so that reuse in the cache 306 can be expected to be high.

In general, the mipmap level λ is computed as λ=log₂ a, where a is the area of the pixel footprint in texel space. If a pixel covers exactly one texel, then there is neither minification nor magnification, a=1, which means that λ=0, indicating exactly no minification or magnification. A threshold aₘᵢₙ may be set and the method 100 and/or system 200 described above may only be used if a≤aₘᵢₙ. For example, where aₘᵢₙ=0.25, which means that if the area is less than a quarter of a texel, then the method 100 and/or system 200 described above may be used. In another embodiment, the largest side in the mipmap level computation may be used for setting the threshold.

### Cooperative Decompression

In an embodiment, a single fat texel could be decompressed cooperatively by all the threads in a warp, distributing the work across the threads. This can lower register pressure as the intermediate storage for decompression can be shared across a warp. It can also improve Single Instruction, Multiple Data (SIMD) utilization as all threads are guaranteed to be doing some work during decompression. Sometimes, this may be strictly needed, for example if the decompressor is a neural network that uses warp-cooperative matrix multiplication accelerators like tensor cores.

If a fat texel is decompressed cooperatively by all the threads, the compiler has to ensure that all threads are active before entering decompress_NTC as shown below in Table 4.

```
TABLE 4
if(result == 0)
{
...
}
else if(result == 1)
{
...
}
else if(result == 3)
{
...
}
ifany(result == 2) // if any thread requires a fat texel decompression
{
  // Compiler saves active thread state
  // Compiler makes all threads active and all registers used below are marked as potentially
interfering with registers in the other branches
        uint mask = −1;
    uint lane = 0;
    // Iterate over unique network parameters in the SIMD group.
    for (; mask ;) {
      // Broadcast the parameter C across SIMD lanes.
      uint Cu = WaveReadLaneAt(C, lane);
      bool matchingLanes = offset == paramOffsets;
      Pu = decompress_NTC(Cu);
      // Store the outputs for matching lanes.
      if (matchingLanes)
          P = Pu
      // Clear the evaluated lanes.
      mask −= WaveActiveBallot(matchingLanes).x;
      lane = firstbitlow(mask);
      ftc_wait_for_free_cacheline(Cu); // There must be a spot in the cache to proceed.
      ftc_store(C, Pu);
    }
  // Compiler restores active thread state
}
```

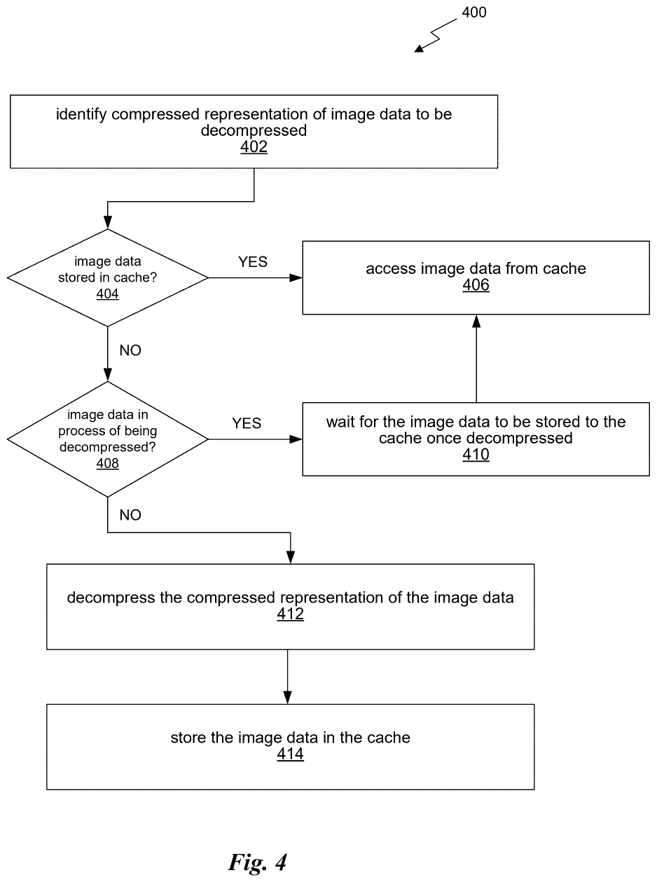

FIG. 4 illustrates a flowchart of a method 400 for consulting a cache during image data decompression, in accordance with an embodiment. The method 400 may be carried in the context of the system 200 of FIG. 2, for example. The method 400 may be carried out by the processor 202 of FIG. 2 when executing shader code.

In operation 402, a compressed representation of image data to be decompressed is identified. In decision 404, it is determined whether the image data is stored in cache. When it is determined that the image data is stored in cache, then the image data is accessed from the cache in operation 406 and the method 400 ends.

When it is determined that the image data is not stored in cache, then it is determined in decision 408 whether the image data is in the process of being decompressed (i.e. by another thread). When it is determined that the image data is in the process of being decompressed, then the method 400 waits until the image data is stored in the cache once decompressed, as shown in operation 410, and then the image data is accessed from the cache in operation 406 and the method 400 ends.

When it is determined that the image data is not in the process of being decompressed, then the compressed representation of image data is decompressed, as shown in operation 412. The image data is then stored in the cache, as shown in operation 414.

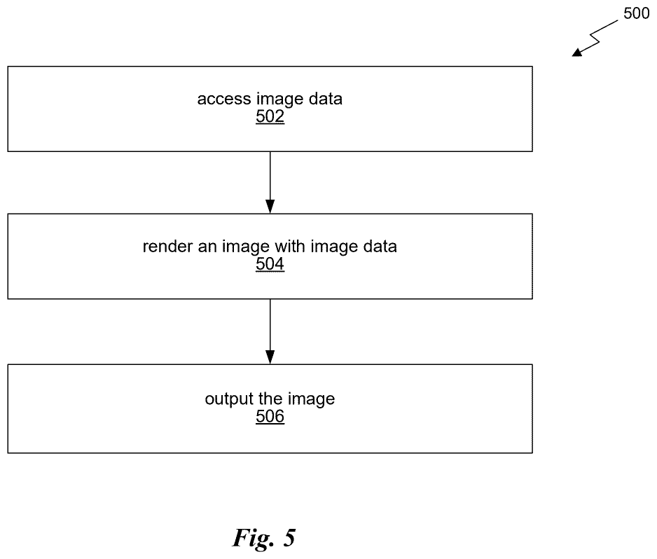

FIG. 5 illustrates a flowchart of a method 500 for using decompressed image data to render an image, in accordance with an embodiment. The method 500 may be carried out once the image data is obtained, per the method 100 of FIG. 1, the method 400 of FIG. 4, and/or the system 200 of FIG. 2.

In operation 502, image data is accessed. In operation 504, an image is rendered with the image data. For example, where the image data is a texture, the image may be rendered to include the texture. In operation 506, the image is output. For example, the image may be output to a memory or to a display device.

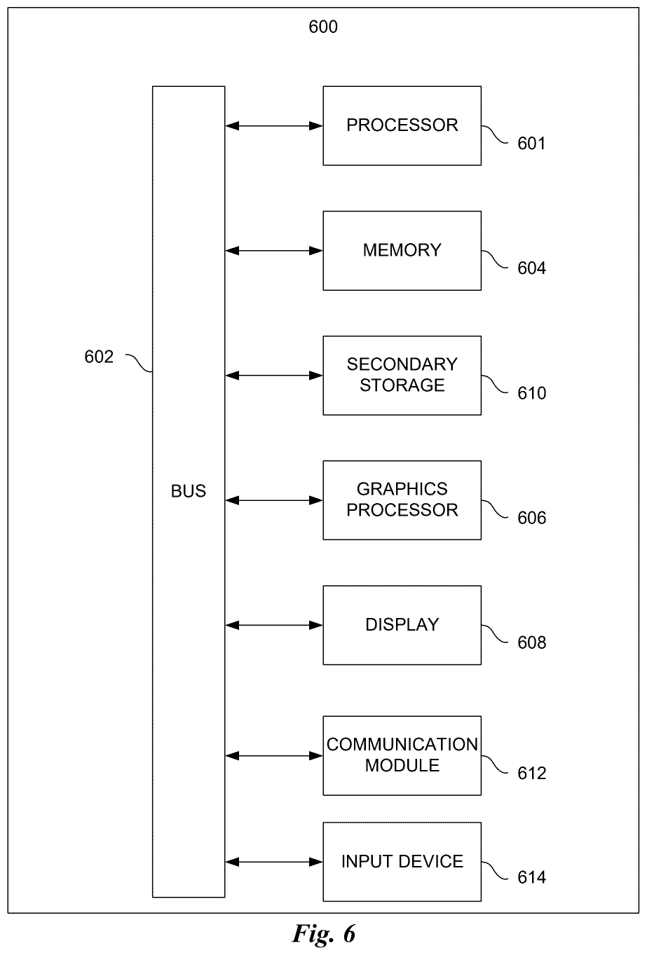

FIG. 6 illustrates an exemplary computing system 600, in accordance with an embodiment. The exemplary computing system 600 may be implemented to carry out any of the methods described herein. For example, the exemplary computing system 600 may perform the image data decompression described above, and in some embodiments may also perform the image rendering as described above.

As shown, the system 600 includes at least one central processor 601 which is connected to a communication bus 602. The system 600 also includes main memory 604 [e.g. random access memory (RAM), etc.]. The system 600 also includes a graphics processor 606. In some embodiments, the system 600 includes a display 608.

The system 600 may also include a secondary storage 610. The secondary storage 610 includes, for example, a hard disk drive and/or a removable storage drive, representing a floppy disk drive, a magnetic tape drive, a compact disk drive, a flash drive or other flash storage, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions, including for example performing image data decompression. Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices (e.g. game consoles, personal computers, servers etc.) through a variety of possible standard or proprietary wired or wireless communication protocols (e.g. via Bluetooth, Near Field Communication (NFC), Cellular communication, etc.).

As also shown, in some embodiments the system 600 may include one or more input devices 614. The input devices 614 may be a wired or wireless input device. In various embodiments, each input device 614 may include a keyboard, touch pad, touch screen, game controller, remote controller, or any other device capable of being used by a user to provide input to the system 600.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
at a device:
responsive to identifying a compressed representation of image data that is to be decompressed, determining whether the image data is stored in a cache;
when the image data is stored in the cache, accessing the image data from the cache.

2. The method of claim 1, wherein the image data includes at least a portion of a texture.

3. The method of claim 1, wherein the image data includes at least a portion of a set of textures.

4. The method of claim 3, wherein the set of textures represents a material.

5. The method of claim 4, wherein each texture of set of textures represents a different property of the material.

6. The method of claim 1, wherein the image data is a texel.

7. The method of claim 1, wherein the image data is of a plurality of texels.

8. The method of claim 1, wherein the compressed representation of the image data has been generated using at least one compression method.

9. The method of claim 1, wherein the compressed representation of the image data has been learned using a neural network.

10. The method of claim 1, wherein the image data is stored in the cache when the compressed representation of the image data has been previously decompressed.

11. The method of claim 1, wherein determining whether the image data is stored in the cache includes:
sending a request to a hardware unit with an address of the image data, and
receiving a response from the hardware unit indicating whether the image data is stored in the cache.

12. The method of claim 11, wherein the hardware unit includes the cache.

13. The method of claim 11, wherein when the response from the hardware unit indicates that the image data is not stored in the cache and that the compressed representation of the image data is not currently in the process of being decompressed by another thread, then further comprising, at the device:
decompressing the compressed representation of the image data.

14. The method of claim 13, wherein the hardware unit includes a queue configured with a counter that tracks when the compressed representation of the image data is currently in the process of being decompressed.

15. The method of claim 13, wherein when there is space in a queue of the hardware unit for a counter for the image data, then updating the counter for the image data in the queue to indicate that the compressed representation of the image data is in the process of being decompressed.

16. The method of claim 15, further comprising, at the device:
after the decompressing is complete, storing the image data in the cache and updating the counter for the image data in the queue to indicate that the compressed representation of the image data is not in the process of being decompressed.

17. The method of claim 16, wherein after the counter for the image data is updated in the queue, a current value of the counter is stored with the image data in the cache.

18. The method of claim 11, wherein when the response from the hardware unit indicates that the image data is not stored in the cache and that the compressed representation of the image data is currently in the process of being decompressed by another thread, then further comprising, at the device:
waiting for the image data to be stored to the cache once decompressed by the other thread, and
after the image data is stored to the cache by the other thread, accessing the image data from the cache.

19. The method of claim 18, wherein the hardware unit includes a queue configured with a counter that tracks when the compressed representation of the image data is currently in the process of being decompressed by a thread as well as a number of additional threads waiting to access the image data once the decompression is complete.

20. The method of claim 19, wherein the counter is updated to indicate that a current thread is waiting for the image data to be stored to the cache once decompressed by the other thread.

21. The method of claim 18, further comprising, at the device:
while waiting for the image data to be stored to the cache, switching processing to another compressed representation of other image data that is to be decompressed.

22. The method of claim 11, wherein the cache includes a counter that tracks a number of threads accessing the image data from the cache.

23. The method of claim 22, wherein the image data is removed from the cache when a value of the counter is zero.

24. The method of claim 22, wherein the image data is removed from the cache when a value of the counter is zero, when the cache is full, and when new image data is to be decompressed and stored in the cache.

25. The method of claim 1, wherein the method is performed by a shader.

26. The method of claim 25, wherein the method is performed by the shader when an area of a pixel footprint in texel space is within a defined threshold.

27. The method of claim 1, wherein the method is performed for each thread of a program tasked with decompressing respective image data.

28. The method of claim 1, wherein determining whether the image data is stored in the cache includes:
sending a request to a hardware unit with an address of the image data, and
receiving a response from the hardware unit that includes one of:
the image data is stored in the cache,
the image data is not stored in the cache and the compressed representation of the image data is not currently in the process of being decompressed by another thread and there is available space in the cache to decompress the compressed representation of the image data to the cache,
the image data is not stored in the cache and the compressed representation of the image data is not currently in the process of being decompressed by another thread and there is no available space in the cache to decompress the compressed representation of the image data to the cache, or
the image data is not stored in the cache and the compressed representation of the image data is currently in the process of being decompressed by another thread.

29. A system, comprising:
a cache to store decompressed image data; and
a processor executing shader code to:
determine, responsive to identifying that a compressed representation of the image data is to be decompressed, whether the image data is stored in the cache, and
when the image data is stored in the cache, access the image data from the cache.

30. A non-transitory computer-readable media storing computer instructions which when executed by one or more processors of a device cause the device to:
responsive to identifying a compressed representation of image data that is to be decompressed, determine whether the image data is stored in a cache;
when the image data is stored in the cache, access the image data from the cache.
